(19) United States
(12) Patent Application Publication
(10) Pub. No.: US 2023/0187627 A1
(43) Pub. Date: Jun. 15, 2023

(54) NON-AQUEOUS ELECTROLYTIC SECONDARY BATTERY AND ASSEMBLED BATTERY

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Takaaki IZUMOTO, Toyohashi-shi (JP); Yusuke TAKASHI, Toyohashi-shi (JP)

(21) Appl. No.: 18/063,687

(22) Filed: Dec. 9, 2022

(30) Foreign Application Priority Data
Dec. 14, 2021 (JP) 2021-202642

(51) Int. Cl. H01M 4/505; H01M 50/538; H01M 4/62; H01M 50/209; H01M 4/525

(52) U.S. Cl. CPC H01M 4/505; H01M 50/538; H01M 4/625; H01M 50/209; H01M 4/525; H01M 2004/021

(57) ABSTRACT

A non-aqueous electrolytic secondary battery includes a rolled electrode assembly including a positive electrode, a negative electrode and a separator, the positive electrode and the negative electrode being rolled with the separator sandwiched between the positive and negative electrodes; a non-aqueous electrolytic solution; and a quadrangular battery case accommodating the rolled electrode assembly and the non-aqueous electrolytic solution. The positive electrode includes a positive electrode active material layer containing at least a positive electrode active material and carbon nanotubes as a conductive material. The negative electrode includes a negative electrode active material layer containing a negative electrode active material. Where a void volume per unit area of the negative electrode active material layer is A (cm³/cm²) and a void volume per unit area of the positive electrode active material layer is B (cm³/cm²), the non-aqueous electrolytic secondary battery satisfies 0.6≤B/A≤1.2.

### CROSS REFERENCE TO RELATED APPLICATIONS

The present application claims priority from Japanese Patent Application No. 2021-202642 filed on Dec. 14, 2021, which is incorporated by reference herein in its entirety.

### BACKGROUND

The present disclosure relates to a non-aqueous electrolytic secondary battery and an assembled battery.

Recently, non-aqueous electrolytic secondary batteries (e.g., lithium ion secondary batteries) are preferably used as portable power sources for personal computers, mobile phones and the like, or driving power sources mountable on vehicles such as hybrid electric vehicles (HEVs), plug-in hybrid electric vehicles (PHEVs), battery electric vehicles (BEVs), and the like. This type of non-aqueous electrolytic secondary battery has a structure in which, for example, an electrode assembly including a positive electrode and a negative electrode and an electrolytic solution are accommodated in a battery case. Examples of such a secondary battery are described in Japanese Laid-Open Patent Publication No. 2020-184436 and Japanese Laid-Open Patent Publication No. 2016-009532.

Japanese Laid-Open Patent Publication No. 2020-184436 discloses that resistance characteristics and overcharge characteristics of a secondary battery are improved by regulating the ratio between lithium bis(oxalate) borate (LiBOB) in a non-aqueous electrolytic solution and sodium in the battery, and the ratio between a void volume of a negative electrode and a void volume of a separator, to predetermined ranges. Japanese Laid-Open Patent Publication No. 2016-009532 discloses the following: a predetermined additive is incorporated into an electrolytic solution, and the ratio among a void volume of a positive electrode, a void volume of a negative electrode, and a void volume of a separator is regulated to a predetermined range; in this manner, the balance between components obtained by decomposition of only the additive and components obtained by decomposition of the additive and a solvent is adjusted; and as a result, a good cover film is formed on the negative electrode. It is disclosed that an effect of the cover film suppresses heat generation at the time of short circuiting and thus improves the thermal stability of an electrode assembly.

### SUMMARY OF THE INVENTION

In the case where a non-aqueous electrolytic secondary battery repeats charge and discharge (especially, high-rate charge and discharge), a pump effect is caused by expansion and contraction of an electrode assembly or by volumetric expansion of a non-aqueous electrolytic solution, and as a result, the non-aqueous electrolytic solution may be extruded from the inside of the electrode assembly. The extruded non-aqueous electrolytic solution tends not to return to the inside of the electrode assembly. Therefore, in the case where the non-aqueous electrolytic solution is excessively extruded from the electrode assembly, the salt concentration inside the electrode assembly becomes non-uniform, which may undesirably deteriorate resistance characteristics or high-rate characteristics.

As a result of active studies made by the present inventors, it has been found out to be difficult for the technologies disclosed in Japanese Laid-Open Patent Publication No. 2020-184436 and Japanese Laid-Open Patent Publication No. 2016-009532 to suppress the non-uniformity of the salt concentration, which is caused by such ejection of the non-aqueous electrolytic solution from the electrode assembly caused by the repetition of expansion and contraction of the electrode assembly at the time of high-rate charge and discharge. Therefore, development of a technology that provides both of superb resistance characteristics and superb high-rate characteristics of a non-aqueous electrolytic secondary battery is desired.

The present disclosure, made in light of such points, has a main object of providing a non-aqueous electrolytic secondary battery having both of superb resistance characteristics and superb high-rate characteristics. Another object of the present disclosure is to provide an assembled battery including such a non-aqueous electrolytic secondary battery.

In order to realize the objects, a non-aqueous electrolytic secondary battery disclosed herein is provided. The non-aqueous electrolytic secondary battery disclosed herein includes a rolled electrode assembly including a positive electrode, a negative electrode and a separator, the positive electrode and the negative electrode being rolled with the separator being sandwiched between the positive electrode and the negative electrode; a non-aqueous electrolytic solution; and a quadrangular battery case accommodating the rolled electrode assembly and the non-aqueous electrolytic solution. The positive electrode includes a positive electrode active material layer containing at least a positive electrode active material and carbon nanotubes as a conductive material. The negative electrode includes a negative electrode active material layer containing a negative electrode active material. Where a void volume per unit area of the negative electrode active material layer is A (cm³/cm²) and a void volume per unit area of the positive electrode active material layer is B (cm³/cm²), the non-aqueous electrolytic secondary battery satisfies 0.6≤B/A≤1.2.

In the non-aqueous electrolytic secondary battery having this structure, the ratio between the volumes of the voids in the positive electrode active material layer and the negative electrode active material layer, which may act as ejection and absorption paths of the non-aqueous electrolytic solution at the time of charge and discharge (especially, high-rate charge and discharge), is adjusted to be in the above-described range. This suppresses the ejection of the non-aqueous electrolytic solution in an excessive amount from the rolled electrode assembly, and thus suppresses the non-uniform salt concentration in the rolled electrode assembly. Therefore, the resistance of the non-aqueous electrolytic secondary battery is decreased, and also the resistance increase ratio at the time of high-rate charge and discharge is decreased. According to such a structure, a non-aqueous electrolytic secondary battery having both of superb resistance characteristics and superb high-rate characteristics is realized.

In an embodiment of the non-aqueous electrolytic secondary battery disclosed herein, the separator is porous, and where a void volume per unit area of the separator is C (cm³/cm²), the non-aqueous electrolytic secondary battery satisfies 0.6≤B/A≤1.2 and 0.6≤C/A≤0.71.

According to such a structure, the ratio among the volumes of the voids in the positive electrode active material layer, the negative electrode active material layer and the separator, which may act as ejection and absorption paths of the non-aqueous electrolytic solution at the time of charge and discharge (especially, high-rate charge and discharge), is adjusted. Therefore, a battery having both of superb resistance characteristics and superb high-rate characteristics is provided.

In an embodiment of the non-aqueous electrolytic secondary battery disclosed herein, the void volume A per unit area of the negative electrode active material layer may be 0.0014 cm³/cm² or larger and 0.0016 cm³/cm² or smaller. The void volume B per unit area of the positive electrode active material layer may be 0.0009 cm³/cm² or larger and 0.0016 cm³/cm² or smaller. The void volume C per unit area of the separator may be 0.0007 cm³/cm² or larger and 0.0011 cm³/cm² or smaller.

According to such a structure, a battery having both of superb resistance characteristics and superb high-rate characteristics in a more preferred manner is provided.

In an embodiment of the non-aqueous electrolytic secondary battery disclosed herein, where a total weight of the positive electrode active material layer is 100% by weight, the carbon nanotubes are contained in the positive electrode active material layer at a content of 0.5% by weight or higher and 5% by weight or lower.

According to such a structure, a positive electrode maintaining a relatively high density and also a preferred void volume is provided. This decreases the initial resistance of the positive electrode, and also decreases the resistance increase ratio at the time of high-rate charge and discharge. Therefore, a battery having both of superb resistance characteristics and superb high-rate characteristics is provided.

In order to realize another object, an assembled battery disclosed herein is provided. The assembled battery disclosed herein includes a plurality of the non-aqueous electrolytic secondary batteries described above. The plurality of non-aqueous electrolytic secondary batteries are aligned in a predetermined direction, and the plurality of non-aqueous electrolytic secondary batteries are restrained so as to be supplied with a load in a direction in which the plurality of non-aqueous electrolytic secondary batteries are aligned.

The assembled battery is structured using the non-aqueous electrolytic secondary batteries in each of which the ratio among the void volumes is adjusted. Therefore, an assembled battery having a low initial resistance and a low resistance increase ratio at the time of high-rate charge and discharge even in a state where the non-aqueous electrolytic secondary batteries are restrained is provided.

### BRIEF DESCRIPTION OF THE DRAWINGS

FIG. 1 is a vertical cross-sectional view schematically showing an internal structure of a lithium ion secondary battery according to an embodiment.

FIG. 2 is a schematic view showing a structure of a rolled electrode assembly of the lithium ion secondary battery according to an embodiment.

FIG. 3 is a perspective view of an assembled battery according to an embodiment.

FIG. 4 is a graph showing the relationship, obtained by results of examples and comparative examples, of the ratio between void volumes per unit area of a positive electrode active material layer and a negative electrode active material layer, with respect to the resistance increase ratio at the time of high-rate charge and discharge.

FIG. 5 is a graph showing the relationship, obtained by results of the examples and the comparative examples, of the ratio of void volumes per unit area of the negative electrode active material layer and a separator, with respect to the resistance increase ratio at the time of high-rate charge and discharge.

### DETAILED DESCRIPTION OF THE PREFERRED EMBODIMENTS

Hereinafter, an embodiment of a secondary battery disclosed herein will be described. The embodiment described herein is not intended to specifically limit the technology disclosed herein, needless to say. The technology disclosed herein is not limited to the embodiment described herein, unless otherwise specified. The drawings are drawn schematically, and do not necessarily reflect an actual product. In the drawings, components or portions having the same functions will bear the same reference signs, and overlapping descriptions may be omitted or simplified. In the drawings, the relationship between sizes (length, width, thickness, etc.) do not reflect the actual relationship between sizes. The expression “A to B” representing a numerical range indicates “A or more and B or less” unless otherwise specified.

In this specification, the term “non-aqueous electrolytic secondary battery” refers to a secondary battery using a non-aqueous electrolytic solution, and encompasses so-called storage batteries such as a lithium ion secondary battery, a nickel hydrogen battery, a nickel cadmium battery and the like, and also encompasses capacitors such as an electric double layer capacitor and the like. Hereinafter, an embodiment of a lithium ion secondary call, among the non-aqueous electrolytic secondary batteries listed above, will be described.

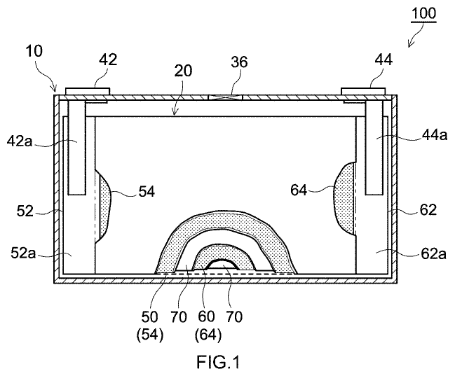

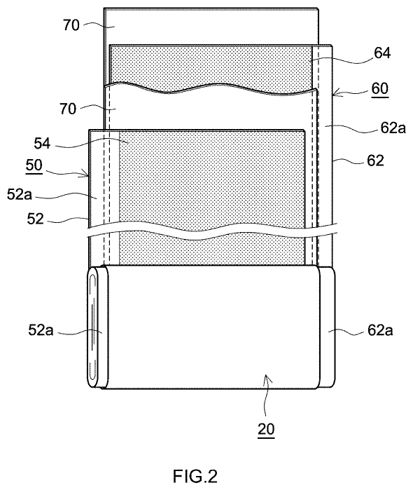

FIG. 1 is a vertical cross-sectional view schematically showing an internal structure of a non-aqueous electrolytic secondary battery according to an embodiment. FIG. 2 is a schematic view showing a structure of a rolled electrode assembly of the non-aqueous electrolytic secondary battery according to an embodiment. As shown in FIG. 1, a lithium ion secondary battery 100 includes a flat rolled electrode assembly 20 and a battery case 10. The lithium ion secondary battery 100 further includes a non-aqueous electrolytic solution (not shown).

The lithium ion secondary battery 100 shown in FIG. 1 has a structure in which the flat rolled electrode assembly 20 and the non-aqueous electrolytic solution (not shown) are accommodated in a flat quadrangular battery case (i.e., outer case) 10. The battery case 10 is provided with a positive electrode terminal 42 and a negative electrode terminal 44 both for connection with an external device, and a thin safety valve 36, which is set to release an inner pressure of the battery case 10 in the case where the inner pressure is raised to a predetermined level or higher. The battery case 10 includes a liquid injection opening (not shown) through which the non-aqueous electrolytic solution is to be injected. The positive electrode terminal 42 is electrically connected with a positive electrode current collector 42a. The negative electrode terminal 44 is electrically connected with a negative electrode current collector 44a. The battery case 10 is formed of, for example, a metal material that is lightweight and has a high thermal conductivity, such as aluminum or the like.

The rolled electrode assembly 20 includes a positive electrode 50 having a shape of a lengthy sheet, a negative electrode 60 having a shape of a lengthy sheet, and a separator 70 having a shape of a lengthy sheet. The rolled electrode assembly 20 has a form in which the positive electrode 50 and the negative electrode 60 are stacked on each other with two separators 70 being sandwiched between the positive and negative electrodes 50 and 60 and are rolled in a longitudinal direction. The rolled electrode assembly 20 has a flat outer shape.

As shown in FIG. 1 and FIG. 2, the positive electrode 50 includes a lengthy positive electrode current collector 52 and a positive electrode active material layer 54 formed on one surface of, or both of two surfaces of, the positive electrode current collector 52 (in this example, formed on both of two surfaces of the positive electrode current collector 52) in the longitudinal direction. The positive electrode current collector 52 includes a positive electrode current collector exposed portion 52a, in which the positive electrode active material layer 54 is not provided, along an end in a width direction of the positive electrode current collector 52 (along a left end in FIG. 1 and FIG. 2). The positive electrode 50 is electrically connected with the positive electrode terminal 42 via the positive electrode current collector 42a provided on the positive electrode current collector exposed portion 52a. The positive electrode current collector 52 is, for example, an aluminum foil or the like. The positive electrode current collector 52 has a size that is not specifically limited, and the size thereof may be determined appropriately in accordance with the design of the battery. The positive electrode current collector 52 has a thickness that is not specifically limited. The thickness thereof is, for example, 5 μm or greater and 35 μm or less, and preferably 7 μm or greater and 20 μm or less.

The negative electrode 60 includes a lengthy negative electrode current collector 62 and a negative electrode active material layer 64 formed on one surface of, or both of two surfaces of, the negative electrode current collector 62 (in this example, formed on both of two surfaces of the negative electrode current collector 62) in the longitudinal direction. The negative electrode current collector 62 includes a negative electrode current collector exposed portion 62a, in which the negative electrode active material layer 64 is not provided, along an end in the width direction of the negative electrode current collector 62 (along a right end in FIG. 1 and FIG. 2). The negative electrode 60 is electrically connected with the negative electrode terminal 44 via the negative electrode current collector 44a provided on the negative electrode current collector exposed portion 62a. The negative electrode current collector 62 is, for example, a copper foil or the like. The negative electrode current collector 62 has a size that is not specifically limited, and the size thereof may be determined appropriately in accordance with the design of the battery. The negative electrode current collector 62 has a thickness that is not specifically limited. The thickness thereof is, for example, 5 μm or greater and 35 μm or less, and preferably 7 μm or greater and 20 μm or less.

The positive electrode active material layer 54 of the lithium ion secondary battery 100 disclosed herein contains at least a positive electrode active material and carbon nanotubes as a conductive material. As the positive electrode active material contained in the positive electrode active material layer 54, one or at least two of various materials known as being usable for a positive electrode of a non-aqueous electrolytic secondary battery are usable with no specific limitation. Preferred examples of such a material include lithium transfer metal composite oxides such as a lithium nickel-based composite oxide, a lithium nickel manganese-based composite oxide, a lithium nickel cobalt manganese-based composite oxide, a lithium nickel cobalt aluminum-based composite oxide, and the like.

As the positive electrode active material, a material having the composition represented by formula (1) below is preferred although the preferred positive electrode active material is not limited to such a material.

Li_{α}(NiₓCo_{y}Mn_{z})O₂ (1)

In formula (1), α, x, y and z respectively satisfy 1≤α≤1.2, 0≤x≤1, 0≤y≤1, 0≤z≤1 and also satisfy x+y+z=1.

The positive electrode active material is contained in the positive electrode active material layer 54 at a content that is not specifically limited (i.e., the content of the positive electrode active material with respect to the total weight of the positive electrode active material layer 54 is not specifically limited). The content thereof is preferably 80% by weight or higher, more preferably 90% by weight or higher and 99% by weight or lower, still preferably 95% by weight or higher and 99% by weight or lower, and especially preferably 95% by weight or higher and 98.3% by weight or lower. In the case where the content of the positive electrode active material in the positive electrode active material layer 54 is in such a range, a battery having a high energy density is provided.

The positive electrode active material layer 54 contains carbon nanotubes as a conductive material in addition to the positive electrode active material. A carbon nanotube (hereinafter, referred to also as the “CNT”) guarantees a preferred conductivity with a small amount and also guarantees an appropriate void ratio, and therefore, is preferably used as a conductive material of a non-aqueous electrolytic secondary battery disclosed herein. The CNTs are contained in the positive electrode active material layer 54 at a content that is preferably 5% by weight or lower. The content of the CNTs in the positive electrode active material layer 54 may be 4% by weight or lower, 3% by weight or lower, or 2% by weight or lower. In order to guarantee both of a preferred conductivity and a preferred void ratio, the content of the CNTs in the positive electrode active material layer 54 is preferably 0.5% by weight or higher, more preferably 0.6% by weight or higher, and especially preferably 0.8% by weight or higher.

The CNTs are conductive. The CNTs have a high tap density, and therefore, maintain a high void ratio even if being aggregated. The CNTs may each be a single-walled carbon nanotube (SWNT) formed of one cylindrical graphene sheet, a double-walled carbon nanotube (DWNT) formed of two different SWNTs in a nested state, or a multi-walled carbon nanotube (MWNT) formed of three or more different SWNTs in a nested state. One of these may be used independently, or two or more of these may be used in combination. The CNTs may be produced by an arc discharge method, a laser ablation method, a chemical vapor deposition method, or the like.

The CNTs have an average length that is not specifically limited. In the case where the average length of the CNTs is too long, the CNTs are aggregated and are not uniformly dispersed. In this case, it tends to be difficult to obtain an effect of improving the conductivity. Therefore, the average length of the CNTs is, for example, preferably 100 μm or shorter, more preferably 75 μm or shorter, and especially preferably 50 μm or shorter. By contrast, in the case where the average length of the CNTs is too short, it tends to be difficult to form a conductive network between particles of the positive electrode active material. Therefore, the average length of the CNTs is preferably 1 μm or longer, more preferably 5 μm or longer, and especially preferably 10 μm or longer. For example, CNTs having an average length of 1 μm or longer and 50 μm or shorter are preferred.

The CNTs have an average diameter that is not specifically limited. The average diameter of the CNTs is, for example, preferably 1 nm or longer and 30 nm or shorter, more preferably 5 nm or longer and 20 nm or shorter, and still more preferably 6 nm or longer and 12 nm or shorter.

The average length and the average diameter of the CNTs may be, for example, values obtained by a measurement based on an observation with an electronic microscope.

The CNTs have a specific area size that is not specifically limited. From the point of view of forming a conductive network in a more preferred manner, the specific area size of the CNTs is preferably 100 m²/g or larger, more preferably 150 m²/g or larger, and still more preferably 200 m²/g or larger. By contrast, from the point of view of suppressing the aggregation of the CNTs and dispersing the CNTs as the conductive material in the positive electrode active material in a preferred manner, the specific area size of the CNTs is preferably 350 m²/g or smaller, more preferably 300 m²/g or smaller, and still more preferably 275 m²/g or smaller.

In this specification, the “specific surface area of the CNTs” refers to a specific surface area measured by nitrogen adsorption by use of a BET method. This may be measured in compliance with JIS Z8830:2013.

The positive electrode active material layer 54 may contain a conductive material other than carbon nanotube as long as the effect of the present disclosure is not significantly spoiled. Examples of such a conductive material include carbon black such as acetylene black, ketjen black and the like; and carbon materials such as activated carbon, graphite and the like. In the case where such a conductive material is incorporated in addition to the carbon nanotubes, the content of the entire conductive material in the positive electrode active material layer 54 may be 0.5% by weight or higher and 10% by weight or lower (e.g., 0.8% by weight or higher and 6% by weight or lower).

The positive electrode active material layer 54 may contain a component other than the positive electrode active material and the conductive material, for example, a binder or the like. Examples of the binder include halogenated vinyl resin such as poly(vinylidene fluoride) (PVdF) and the like, and poly(alkylene oxide) such as poly(ethylene oxide) (PEO) and the like, etc. The binder is contained in the positive electrode active material layer 54 at a content that is not specifically limited. The content thereof is preferably 0.5% by weight or higher and 5% by weight or lower, more preferably 0.7% by weight or higher and 3% by weight or lower, and still more preferably 0.9% by weight or higher and 2.5% by weight or lower.

The positive electrode active material layer 54 may have an average thickness and a weight per unit area that are adjusted so as to satisfy the ratio between void volumes per unit area of the positive electrode active material layer, the negative electrode active material layer and the separator described below. For example, the average thickness of the positive electrode active material layer 54 may be 20 μm or greater, 30 μm or greater, 39.7 μm or greater, 40 μm or greater, 42.7 μm or greater, or 43.6 μm or greater. The average thickness of the positive electrode active material layer 54 may be 100 μm or less, 75 μm or less, 53 μm or less, 48.5 μm or less, or 47 μm or less. The weight per unit area of the positive electrode active material layer 54 may be 3 mg/cm² or heavier (e.g., 5 mg/cm² or heavier) and 70 mg/cm² or lighter (e.g., 50 mg/cm² or lighter) for one surface of the positive electrode current collector 52.

The negative electrode active material layer 64 contains a negative electrode active material. As the negative electrode active material contained in the negative electrode active material layer 64, one or at least two of various materials known as being usable for a negative electrode of a non-aqueous electrolytic secondary battery are usable with no specific limitation. Preferred examples of such a material include carbon materials such as graphite, hard carbon, soft carbon, and the like. The negative electrode active material may be amorphous-coated graphite including granular natural graphite and amorphous carbon (e.g., carbon black) coating a surface thereof. The negative electrode active material is contained in the negative electrode active material layer 64 at a content that is not specifically limited (i.e., the content of the negative electrode active material with respect to the total weight of the negative electrode active material layer 64 is not specifically limited). The content thereof is preferably 90% by weight or higher, more preferably 95% by weight or higher, and still more preferably 99% by weight or higher.

The negative electrode active material layer 64 may contain a component other than the negative electrode active material, for example, a thickener, a binder, a dispersant or the like. Examples of the thickener include cellulose such as carboxymethyl cellulose (CMC), methylcellulose (MC), and the like. The thickener is contained in the negative electrode active material layer 64 at a content that is preferably 0.3% by weight or higher and 3% by weight or lower, and more preferably 0.5% by weight or higher and 2% by weight or lower. Examples of the binder include rubber such as styrene butadiene rubber (SBR) and the like, and halogenated vinyl resin such as poly (vinylidene fluoride) (PVdF) and the like. The binder is contained in the negative electrode active material layer 64 at a content that is preferably 0.1% by weight or higher and 5% by weight or lower, and more preferably 0.5% by weight or higher and 3% by weight or lower.

The negative electrode active material layer 64 may have an average thickness and a weight per unit area that are adjusted so as to satisfy the ratio between void volumes per unit area of the positive electrode active material layer, the negative electrode active material layer and the separator described below. For example, the average thickness of the negative electrode active material layer 64 may be 50 μm or greater, 60 μm or greater, 60.6 μm or greater, or 61.6 μm or greater. The average thickness of the negative electrode active material layer 64 may be 100 μm or less, 75 μm or less, 65.6 μm or less, 65.4 μm or less, or 65 μm or less. The weight per unit area of the negative electrode active material layer 64 may be 5 mg/cm² or heavier (e.g., 7 mg/cm² or heavier) and 20 mg/cm² or lighter (e.g., 15 mg/cm² or lighter) for one surface of the negative electrode current collector 62.

The separator 70 is located between the positive electrode active material layer 54 of the positive electrode 50 and the negative electrode active material layer 64 of the negative electrode 60. The separator 70 isolates the positive electrode active material layer 54 of the positive electrode 50 and the negative electrode active material layer 64 of the negative electrode 60 from each other. The separator 70 is formed of a porous resin substrate. The resin substrate may be a sheet (film) formed of a resin such as polyolefin, for example, polyethylene (PE), polypropylene (PP) or the like; polyester; polyamide; cellulose; or the like. The separator 70 may have a single-layer structure or a structure having a stack of two or more porous resin sheets different in the property or nature (thickness, void ratio, etc.) (e.g., a three-layer structure including a PE layer and PP layers stacked on both of two surfaces of the PE layer). The separator 70 may include a heat resistant layer (HRL layer), formed of ceramic particles or the like, at a surface thereof.

The separator 70 may have any thickness and any void ratio that are adjusted so as to satisfy the ratio between void volumes per unit area of the positive electrode active material layer, the negative electrode active material layer and the separator described below. For example, the thickness of the separator 70 may be 10 μm or greater, 15 μm or greater, or 18 μm or greater. The thickness of the separator 70 may be 30 μm or less, 25 μm or less, or 20 μm or less. The void ratio of the separator 70 may be 45% or higher, 50% or higher, or 53% or higher, and may be, for example, 60% or lower, or 55% or lower. The void ratio may be measured by, for example, a mercury porosimetry method using a mercury porosimeter.

Where the void volume per unit area of the negative electrode active material layer 64 is A (cm³/cm²) and the void volume per unit area of the positive electrode active material layer 54 is B (cm³/cm²), the non-aqueous electrolytic secondary battery disclosed herein satisfies 0.6≤B/A≤1.2. More preferably, the non-aqueous electrolytic secondary battery may satisfy 0.6≤B/A≤1.14. Still more preferably, the non-aqueous electrolytic secondary battery may satisfy 0.63≤B/A≤1.14.

In a preferred embodiment, where the void volume per unit area of the separator 70 is C (cm³/cm²), the non-aqueous electrolytic secondary battery satisfies 0.6≤B/A≤1.2 and 0.6≤C/A≤0.71. In a more preferred embodiment, the non-aqueous electrolytic secondary battery satisfies 0.63≤B/A≤1.14 and 0.63≤C/A≤0.71. In the case where the ratio between the void volumes per unit area of the positive electrode active material layer, the negative electrode active material layer and the separator is in such a range, the initial resistance is decreased and the resistance increase ratio at the time of high-rate charge and discharge is suppressed. Namely, a non-aqueous electrolytic secondary battery having both of superb resistance characteristics and superb high-rate characteristics is provided.

These effects are considered to be provided for the following reason although it is not intended to limit the technology disclosed herein. A rolled electrode assembly is expanded and contracted repeatedly at the time of charge and discharge (especially, high-rate charge and discharge). Therefore, a non-aqueous electrolytic solution is repeatedly ejected from the rolled electrode assembly and absorbed into the rolled electrode assembly again through voids in a positive electrode active material layer, a negative electrode active material layer and a separator. The amount of the non-aqueous electrolytic solution ejected from the rolled electrode assembly tends to be larger than the amount of the non-aqueous electrolytic solution absorbed into the rolled electrode assembly again through the voids. In the case where the amount of the ejected non-aqueous electrolytic solution is excessively large, the salt concentration in the rolled electrode assembly may become non-uniform. In order to avoid this, for the non-aqueous electrolytic secondary battery disclosed herein, the volumes of the voids in the positive electrode active material layer, the negative electrode active material layer and the separator, which may act as ejection and absorption paths of the non-aqueous electrolytic solution at the time of charge and discharge, are adjusted to be in the above-described range. This suppresses the ejection of the non-aqueous electrolytic solution in an excessive amount from the rolled electrode assembly, and thus suppresses the non-uniform salt concentration in the rolled electrode assembly. Therefore, a battery having a low initial resistance and a low resistance increase ratio at the time of high-rate charge and discharge is provided.

For the non-aqueous electrolytic secondary battery disclosed herein, the void volume A per unit area of the negative electrode active material layer 64 is preferably 0.0014 cm³/cm² or larger and 0.0016 cm³/cm² or smaller. The void volume B per unit area of the positive electrode active material layer 54 is preferably 0.0009 cm³/cm² or larger, and may be 0.0010 cm³/cm² or larger or 0.0011 cm³/cm² or larger. The void volume B per unit area of the positive electrode active material layer 54 is preferably 0.0016 cm³/cm² or smaller. The void volume C per unit area of the separator 70 is preferably 0.0007 cm³/cm² or larger and 0.0011 cm³/cm² or smaller (e.g., 0.0010 cm³/cm²).

The void volume A per unit area of the negative electrode active material layer 64 and the void volume B per unit area of the positive electrode active material layer 54 may each be found from the “volume per unit area (cm³/cm²) of the active material layer” and the “apparent volume per unit area (cm³/cm²) of the active material layer”. The “volume per unit area (cm³/cm²) of the active material layer” is found as follows. First, a predetermined surface area is punched out from the positive electrode or the negative electrode, and the weight per unit area (mg/cm²) of the active material layer is measured. Next, the composition ratio (weight ratio) of each of the components contained in the active material layer (e.g., active material, binder, thickener, etc.) is divided by the true density (g/cm³) of the respective component. The obtained value is multiplied by the above-measured weight of the active material layer to find the “volume per unit area of the active material layer”. In the case where, for example, the active material layer contains a negative electrode active material, a binder and a thickener, the “volume per unit area (cm³/cm²) of the active material layer” may be found by the following equation: Volume per unit area (cm³/cm²) of the active material layer=weight per unit area of the active material layer {(composition ratio of the negative electrode active material/true density of the negative electrode active material)+(composition ratio of the binder/true density of the binder)+(composition ratio of the thickener/true density of the thickener)}. The true density of each component may be measured by a density meter by use of a common constant volume expansion method (gas pycnometer method) or the like.

Next, the “apparent volume per unit area (cm³/cm²) of the active material layer” is found as follows. First, the thickness (μm) of the active material layer is measured by a micrometer or the like. The “apparent volume per unit area (cm³/cm²) of the active material layer” is found by the following equation: Apparent volume per unit area (cm³/cm²) of the active material layer=thickness (μm) of the active material layer/10000.

The “volume per unit area of the active material layer” is subtracted from the “apparent volume per unit area of the active material layer” to find the void volume per unit area of the active material layer. The void volume A per unit area of the negative electrode active material layer 64 and the void volume B per unit area of the positive electrode active material layer 54 may each be appropriately changed by adjusting the material forming the active material layer, the pressing conditions for the formation of the active material layer, the weight per unit area, the average thickness and the like.

The void volumes C per unit area of the separator may be found from the thickness (μm) and the void ratio (%) of the separator. Specifically, the void volume C per unit area of the separator is found by the following equation:

Void volume per unit area (cm³/cm²) of the separator=(thickness (μm) of the separator/10000)′void ratio (%) of the separator

The void volume C per unit area of the separator 70 may be appropriately changed by adjusting the conditions for making the material of the separator porous (rolling conditions, etc.), the thickness of the separator and the like. A separator having a known air permeability is available, for example, commercially. Therefore, a separator having an air permeability and a thickness suitable for the desired void volume per unit area may be commercially acquired as the separator 70.

It is generally known that in the case where the positive electrode active material layer has a low thickness (i.e., in the case where the void volume of the positive electrode is high), particles of the positive electrode active material, or the positive electrode active material and the conductive material, have poor contactability. Therefore, the resistance of the positive electrode is increased, and as a result, the non-aqueous electrolytic secondary battery tends to have low output characteristics. In the meantime, as a result of active studies, the present inventors have found that the resistance of the positive electrode is increased also in the case where the positive electrode active material layer has a density of a certain level or higher. In the case where the resistance of the positive electrode is increased, the rolled electrode assembly tends to generate more heat, and the volume expansion ratio of the non-aqueous electrolytic solution and the expansion and contraction ratio of the rolled electrode assembly tend to be increased, at the time of charge and discharge (especially, high-rate charge and discharge). This causes the non-aqueous electrolytic solution to be ejected easily in an excessive amount from the rolled electrode assembly. Therefore, a non-aqueous electrolytic secondary battery having an increased resistance of the positive electrode has a high resistance increase ratio at the time of high-rate charge and discharge.

In the non-aqueous electrolytic secondary battery disclosed herein, the positive electrode active material layer 54 may include carbon nanotubes, and may have a density adjusted to be in a predetermined range. Specifically, the density of the positive electrode active material layer 54 is preferably 1.5 g/cm³ or higher, more preferably 1.8 g/cm³ or higher, and still more preferably 2.2 g/cm³ or higher, may be 2.36 g/cm³ or higher, and is especially preferably 2.4 g/cm³ or higher. The density of the positive electrode active material layer 54 is preferably lower than 2.75 g/cm³, and more preferably 2.55 g/cm³ or lower. With such a range of the density of the positive electrode active material layer 54, the initial resistance of the non-aqueous electrolytic secondary battery is decreased, and the resistance increase ratio at the time of high-rate charge and discharge is suppressed.

The positive electrode active material layer 54 has a void ratio that is, for example, preferably 40% or higher, and may be 42.91% or higher, 44.7% or higher, or 46.27% or higher. The void ratio of the positive electrode active material layer 54 is preferably 65% or lower, and may be 60.7% or lower, 52% or lower, 47.7% or lower, or 47.16% or lower.

The negative electrode active material layer 64 has a density that is preferably 1 g/cm³ or higher, and may be 1.1 g/cm³ or higher, 1.14 g/cm³ or higher, or 1.17 g/cm³ or higher. The density of the negative electrode active material layer 64 is preferably 2 g/cm³ or lower, and more preferably 1.5 g/cm³ or lower. The negative electrode active material layer 64 has a void ratio that is, for example, preferably 50% or higher, and more preferably 53% or higher. From the point of view of the energy density, the void ratio of the negative electrode active material layer 64 is preferably 60% or lower.

The lithium ion secondary battery 100 disclosed herein includes a non-aqueous electrolytic solution as described above. The non-aqueous electrolytic solution contains, for example, a non-aqueous solvent and a support salt. As the non-aqueous solvent, any of carbonates, esters, ethers, nitriles, sulfones, lactones and the like may be used with no specific limitation. Specifically, a non-aqueous solvent such as ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluoro dimethyl carbonate (TFDMC), or the like is preferably usable. One of such non-aqueous solvents may be used independently, or two or more thereof may be used in combination appropriately. As the support salt, any support salt conventionally used for this type of non-aqueous electrolytic secondary battery may be used with no specific limitation. For example, any of lithium salts such as LiPF₆, LiBF₄, LiAsF₆, LiCF₃SO₃, LiC₄F₉SO₃, LiN(CF₃SO₂)₂, LiC(CF₃SO₂)₃, and the like may be used. Among these, LiPF₆ is preferably usable. The support salt may have a concentration of, for example, 0.7 mol/L or higher and 1.3 mol/L or lower.

The non-aqueous electrolytic solution of the lithium ion secondary battery 100 disclosed herein may contain an overcharge inhibitor, an anti-freeze agent or the like, but does not contain LiPF₄C₂O₄ or LiPF₂(C₂O₄)₂ as an additive. According to the technology disclosed herein, a battery having both of superb resistance characteristics and superb high-rate characteristics is provided as long as the ratio among the void volumes of the positive electrode active material layer 54, the negative electrode active material layer 64 and the separator 70 is in the above-described range even without any of the additives.

The lithium ion secondary battery 100 having the above-described structure is usable for various uses. Preferred uses include driving power sources mountable on vehicles such as hybrid electric vehicles (HEVs), plug-in hybrid electric vehicles (PHEVs), battery electric vehicles (BEVs), and the like. The lithium ion secondary battery 100 is used in the form of an assembled battery including a plurality of the lithium ion secondary batteries 100 connected in series and/or in parallel. In a specific example of such an assembled battery, a plurality of lithium ion secondary batteries are aligned in a predetermined direction and restrained to be supplied with a load in the alignment direction of the batteries 100.

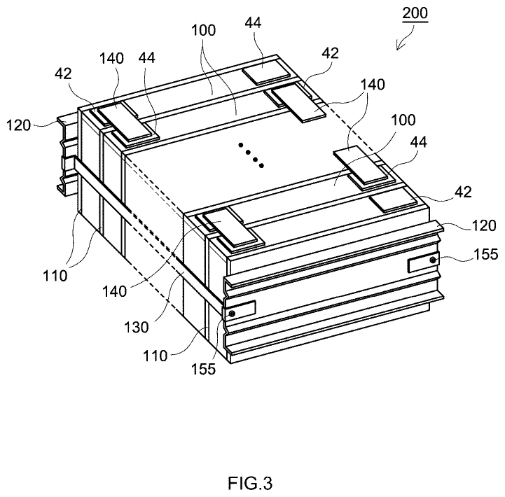

Hereinafter, an example of structure of an assembled battery will be described. FIG. 3 is a perspective view showing a structure of an assembled battery including the non-aqueous electrolytic secondary batteries disclosed herein.

As shown in FIG. 3, an assembled battery 200 includes a plurality of lithium ion secondary batteries (single cells) 100 aligned in a predetermined direction. The batteries 100 are aligned while being inverted alternately, so that the positive electrode terminals 42 and the negative electrode terminals 44 are located alternately. In more detail, the batteries 100 are located such that wide surfaces of the battery cases 10 face each other and narrow surfaces of the battery cases 10 are aligned linearly. Spacers 110 are held between the batteries 100. The spacers 110 may act to dissipate heat efficiently or to adjust the length. There is no specific limitation on the number of the batteries 100 included in the assembled battery 200. The number of the batteries 100 included in the assembled battery 200 is, for example, 10, and preferably 10 or larger and 30 or smaller.

At both of two ends of the aligned batteries 100, a pair of end plates (restraint plates) 120 are provided. Restraint bands 130 for tightening are attached so as to connect the end plates 120 to each other like a bridge. In this manner, the plurality of batteries 100 are restrained such that a predetermined load is applied thereto in the alignment direction of the batteries 100. In more detail, ends of each of the restraint bands are tightened to the end plates 120 by screws 155 to restrain the plurality of batteries 100 such that a predetermined restraint load is applied thereto in the direction in which the batteries 100 are aligned. The batteries 100 are each restrained by a restraint pressure that is not specifically limited. For example, the restraint pressure is set such that the batteries 100 are pressed by a pressure of 0.2 MPa or higher (preferably 0.5 MPa or higher) and 10 MPa or lower (preferably 5 MPa or lower) in the alignment direction of the batteries 100.

For each of the non-aqueous electrolytic secondary batteries disclosed herein, the ratio among the void volumes of the positive electrode active material layer 54, the negative electrode active material layer 64 and the separator 70 is adjusted to be in the above-described range. Therefore, the initial resistance is suppressed and the resistance increase ratio at the time of high-rate charge and discharge is suppressed even when the high-rate charge and discharge is repeated in a state where the battery is restrained at a predetermined restraint pressure. As a result, the assembled battery 200 provides higher battery performance.

Regarding each two batteries 100 adjacent to each other, the positive electrode terminal 42 of one battery and the negative electrode terminal 44 of the other battery are electrically connected to each other by a busbar 140. The batteries 100 are connected to each other in series in this manner, so that the assembled battery 200 having a desired voltage is structured.

Hereinafter, examples of the present disclosure will be described. The present disclosure is not limited to any of the following examples.

### <Production of Lithium Ion Secondary Batteries for Evaluation>

First, LiNi_{1/3}Co_{1/3}Mn_{1/3}O₂ as positive electrode active material powder, carbon nanotubes (CNT) or acetylene black (AB) as a conductive material, and poly(vinylidene fluoride) (PVdF) as a binder were prepared. The prepared carbon nanotubes were multi-walled carbon nanotubes having an average length of 1 μm and an average diameter of 10 nm. These materials were mixed with N-methylpyrrolidone (NMP) at each of weight ratios (wt. %) shown in Table 1 to prepare a slurry for formation of a positive electrode active material layer. The slurry was applied in the form of a strip to both of two surfaces of a lengthy aluminum foil, and pressed after being dried, to form a positive electrode sheet. At this point, the weight per unit area of the positive electrode active material layer and the pressing conditions were varied such that the void volume B per unit area (cm³/cm²) of the positive electrode active material layer would have each of values shown in Table 1.

Next, amorphous-coated natural graphite (C) as a negative electrode active material, styrene butadiene rubber (SBR) as a binder, and carboxymethylcellulose (CMC) as a thickener were prepared. These materials were mixed with ion exchange water as a solvent at each of weight ratios (wt. %) shown in Table 1 to prepare a slurry for formation of a negative electrode active material layer. The slurry was applied in the form of a strip to both of two surfaces of a lengthy copper foil, and pressed after being dried, to form a negative electrode sheet. At this point, the weight per unit area of the negative electrode active material layer and the pressing conditions were varied such that the void volume A per unit area (cm³/cm²) of the negative electrode active material layer would have each of values shown in Table 1.

As a separator, a porous polyolefin sheet having a three-layer structure of PP/PE/PP was used. At this point, the rolling conditions and the pressing conditions were varied such that the void volume C per unit area (cm³/cm²) of the separator would have each of values shown in Table 1.

The positive electrode sheet and the negative electrode sheet formed above and two separators prepared above were stacked, rolled, and then pressed at side surfaces thereof to be crushed. As a result, flat rolled electrode assemblies were formed. The positive electrode terminal and the negative electrode terminal were connected to each of the rolled electrode assemblies, and the rolled electrode assembly was accommodated in a quadrangular battery case having an electrolytic solution injection opening. Next, a non-aqueous electrolytic solution was injected from the electrolytic solution injection opening of the battery case, and the injection opening was sealed in an airtight manner. For preparing the non-aqueous electrolytic solution, ethylene carbonate (EC), ethyl methyl carbonate (EMC) and dimethyl carbonate (DMC) were mixed at a volume ratio of EC:EMC:DMC=3:4:3 to prepare a mixed solvent, and LiPF₆ as a support salt was dissolved in the mixed solvent at a concentration of 1.1 mol/L. Then, an activation process was performed to obtain lithium ion secondary batteries for evaluation in examples and comparative examples.

### <Calculation of the Void Volume Per Unit Area>

First, the void volume A per unit area of one surface of the negative electrode active material layer was calculated by the following equations (1) through (3).

Volume per unit area (cm³/cm²) of the negative electrode active material layer=weight per unit area (mg/cm²) of the negative electrode active material layer′{(composition ratio of the negative electrode active material/true density of the negative electrode active material)+(composition ratio of the binder/true density of the binder)+(composition ratio of the thickener/true density of the thickener)} (1)

Apparent volume per unit area (cm³/cm²) of the negative electrode active material layer=thickness (μm) of the negative electrode active material layer/10000 (2)

Void volume A per unit area of the negative electrode active material layer=(volume per unit area of the negative electrode active material layer)−(apparent volume per unit area of the negative electrode active material layer) (3)

The void volume B per unit area of one surface of the positive electrode active material layer was calculated by the following equations (4) through (6).

Volume per unit area (cm³/cm²) of the positive electrode active material layer=weight per unit area (mg/cm²) of the positive electrode active material layer′{(composition ratio of the positive electrode active material/true density of the positive electrode active material)+(composition ratio of the conducive material/true density of the conducive material)+(composition ratio of the binder/true density of the binder)}+(composition ratio of the thickener/true density of the thickener)} (4)

Apparent volume per unit area (cm³/cm²) of the positive electrode active material layer=thickness (μm) of the positive electrode active material layer/10000 (5)

Void volume B per unit area of the positive electrode active material layer=(volume per unit area of the positive electrode active material layer)−(apparent volume per unit area of the positive electrode active material layer) (6)

The void volume C per unit area of one surface of the separator was calculated by the following mathematical equation (7).

Void volume C per unit area (cm³/cm²) of the separator=(thickness (μm) of the separator/10000)′void ratio (%) of the separator (7)

The void volumes per unit area (cm³/cm²) of one surface of the positive electrode active material layer, one surface of the negative electrode active material layer and one surface of the separator calculated above are shown in Table 1 and Table 2. The ratio of the void volume B per unit area of the positive electrode active material layer with respect to the void volume A per unit area of the negative electrode active material layer, i.e., (B/A), and the ratio of the void volume C per unit area of the separator with respect to the void volume A per unit area of the negative electrode active material layer, i.e., (C/A), were calculated. The results are shown in Table 2.

TABLE 1

| | POSITIVE ELECTRODE | | | | | | | | NEGATIVE | |
|---|---|---|---|---|---|---|---|---|---|---|
| | | | RATIO OF | | | | | | ELECTRODE | |
| | | RATIO OF | CONDUC- | RATIO | | | | VOID | RATIO OF | RATIO OF |
| | TYPE OF | ACTIVE | TIVE | OF | DEN- | THICK- | VOID | VOLUME | ACTIVE | THICK- |
| | CONDUCTIVE | MATERIAL | MATERIAL | BINDER | SITY | NESS | RATIO | B | MATERIAL | ENER |
| | MATERIAL | (w t %) | (w t %) | (w t %) | (g/cm³) | (μm) | (%) | (cm³/cm²) | (w t %) | (w t %) |
| COMPARATIVE | AB | 90.30 | 7.00 | 2.70 | 2.42 | 45.00 | 36.15 | 0.0008 | 99.0 | 0.5 |
| EX 1 | | | | | | | | | | |
| COMPARATIVE | AB | 90.30 | 7.00 | 2.70 | 2.42 | 38.00 | 37.30 | 0.0007 | 99.0 | 0.5 |
| EX 2 | | | | | | | | | | |
| COMPARATIVE | AB | 90.30 | 7.00 | 2.70 | 2.45 | 44.00 | 35.36 | 0.0008 | 99.0 | 0.5 |
| EX 3 | | | | | | | | | | |
| COMPARATIVE | AB | 90.30 | 7.00 | 2.70 | 2.42 | 45.00 | 36.15 | 0.0008 | 99.0 | 0.5 |
| EX 4 | | | | | | | | | | |
| COMPARATIVE | AB | 90.30 | 7.00 | 2.70 | 2.42 | 38.00 | 37.30 | 0.0007 | 99.0 | 0.5 |
| EX 5 | | | | | | | | | | |
| COMPARATIVE | CNT | 98.30 | 0.80 | 0.90 | 1.49 | 63.00 | 67.30 | 0.0021 | 99.0 | 0.5 |
| EX 6 | | | | | | | | | | |
| COMPARATIVE | CNT | 98.30 | 0.80 | 0.90 | 2.75 | 46.40 | 38.43 | 0.0009 | 99.0 | 0.5 |
| EX 7 | | | | | | | | | | |
| EXAMPLE 1 | CNT | 98.30 | 0.80 | 0.90 | 2.55 | 40.00 | 42.91 | 0.0009 | 99.0 | 0.5 |
| EXAMPLE 2 | CNT | 98.30 | 0.80 | 0.90 | 2.40 | 40.00 | 47.70 | 0.0010 | 99.0 | 0.5 |
| EXAMPLE 3 | CNT | 98.30 | 0.80 | 0.90 | 2.20 | 43.00 | 52.00 | 0.0011 | 99.0 | 0.5 |
| EXAMPLE 4 | CNT | 98.30 | 0.80 | 0.90 | 1.80 | 53.00 | 60.70 | 0.0016 | 99.0 | 0.5 |
| EXAMPLE 5 | CNT | 98.30 | 0.80 | 0.90 | 2.40 | 40.00 | 47.70 | 0.0010 | 99.0 | 0.5 |
| EXAMPLE 6 | CNT | 98.30 | 0.80 | 0.90 | 2.55 | 40.00 | 42.91 | 0.0009 | 99.0 | 0.5 |
| EXAMPLE 7 | CNT | 98.30 | 0.80 | 0.90 | 2.40 | 42.70 | 46.27 | 0.0010 | 99.0 | 0.5 |
| EXAMPLE 8 | CNT | 98.30 | 0.80 | 0.90 | 2.47 | 39.70 | 44.70 | 0.0009 | 99.0 | 0.5 |
| EXAMPLE 9 | CNT | 98.30 | 0.80 | 0.90 | 2.36 | 47.00 | 47.16 | 0.0011 | 99.0 | 0.5 |
| EXAMPLE 10 | CNT | 98.30 | 0.80 | 0.90 | 2.40 | 48.50 | 46.27 | 0.0011 | 99.0 | 0.5 |
| EXAMPLE 11 | CNT | 98.30 | 0.80 | 0.90 | 2.55 | 43.60 | 42.91 | 0.0009 | 99.0 | 0.5 |

| | NEGATIVE ELECTRODE | | | | | SEPARATOR | | |
|---|---|---|---|---|---|---|---|---|
| | RATIO | | | | VOID | | | VOID |
| | OF | | THICK- | VOID | VOLUME | VOID | THICK- | VOLUME |
| | BINDER | DENSITY | NESS | RATIO | A | RATIO | NESS | C |
| | (w t %) | (g/cm³) | (μm) | (%) | (cm³/cm²) | (%) | (μm) | (cm³/cm²) |
| COMPARATIVE | 0.5 | 1.14 | 61.00 | 48.48 | 0.0015 | 53.0 | 20.0 | 0.0011 |
| EX 1 | | | | | | | | |
| COMPARATIVE | 0.5 | 1.14 | 58.00 | 48.40 | 0.0014 | 47.0 | 16.0 | 0.0008 |
| EX 2 | | | | | | | | |
| COMPARATIVE | 0.5 | 1.17 | 60.00 | 47.13 | 0.0014 | 47.0 | 16.0 | 0.0008 |
| EX 3 | | | | | | | | |
| COMPARATIVE | 0.5 | 1.09 | 63.00 | 50.74 | 0.0016 | 45.0 | 15.0 | 0.0007 |
| EX 4 | | | | | | | | |
| COMPARATIVE | 0.5 | 1.14 | 58.00 | 48.48 | 0.0014 | 53.0 | 20.0 | 0.0011 |
| EX 5 | | | | | | | | |
| COMPARATIVE | 0.5 | 1.17 | 59.40 | 46.72 | 0.0014 | 53.0 | 18.0 | 0.0010 |
| EX 6 | | | | | | | | |
| COMPARATIVE | 0.5 | 1.14 | 70.00 | 48.48 | 0.0017 | 50.0 | 18.0 | 0.0009 |
| EX 7 | | | | | | | | |
| EXAMPLE 1 | 0.5 | 1.10 | 60.00 | 50.29 | 0.0015 | 53.0 | 18.0 | 0.0010 |
| EXAMPLE 2 | 0.5 | 1.14 | 60.00 | 46.72 | 0.0014 | 53.0 | 18.0 | 0.0010 |
| EXAMPLE 3 | 0.5 | 1.14 | 60.00 | 46.72 | 0.0014 | 53.0 | 18.0 | 0.0010 |
| EXAMPLE 4 | 0.5 | 1.14 | 60.00 | 46.72 | 0.0014 | 53.0 | 18.0 | 0.0010 |
| EXAMPLE 5 | 0.5 | 1.14 | 60.00 | 46.72 | 0.0014 | 53.0 | 18.0 | 0.0010 |
| EXAMPLE 6 | 0.5 | 1.10 | 60.60 | 50.29 | 0.0015 | 53.0 | 18.0 | 0.0010 |
| EXAMPLE 7 | 0.5 | 1.14 | 65.00 | 48.48 | 0.0016 | 53.0 | 18.0 | 0.0010 |
| EXAMPLE 8 | 0.5 | 1.10 | 61.60 | 50.29 | 0.0015 | 53.0 | 18.0 | 0.0010 |
| EXAMPLE 9 | 0.5 | 1.17 | 65.00 | 47.13 | 0.0015 | 53.0 | 18.0 | 0.0010 |
| EXAMPLE 10 | 0.5 | 1.10 | 65.60 | 50.29 | 0.0016 | 53.0 | 18.0 | 0.0010 |
| EXAMPLE 11 | 0.5 | 1.17 | 65.40 | 47.13 | 0.0015 | 53.0 | 18.0 | 0.0010 |

### <Initial Resistance Ratio>

The post-activation process lithium ion secondary batteries for evaluation were each adjusted so as to have an SOC of 60%, and put in an environment of 25° C. Such lithium ion secondary batteries for evaluation were each discharged by a 30C current value for 10 seconds. The voltage drop value ΔV of each battery at this point was obtained, and the resistance of each battery was calculated by use of the current value I and ΔV. The resistance of the lithium ion secondary battery in comparative example 1 was set to 1.00, and the ratio of the resistance of each of the lithium ion secondary batteries for evaluation in examples and the other comparative examples with respect to the resistance set to 1.00 was found. The results are shown in Table 2.

### <High-Rate Resistance Increase Ratio>

The post-activation process lithium ion secondary batteries for evaluation were each adjusted so as to have an SOC of 60%, and put in an environment of 25° C. Such lithium ion secondary batteries for evaluation were each subjected to 2000 cycles of charge and discharge. In one cycle of charge and discharge, the battery was charged by a 30C current value for 10 seconds, kept in pause for 10 seconds, discharged by a 10C current value for 30 seconds, and kept in pause for 10 seconds. The resistance of each battery was calculated by the same method as used for the initial resistance ratio. Based on the ratio of the resistance value after 2000 cycles with respect to the initial resistance value, the high-rate resistance increase ratio was calculated. The results are shown in Table 2.

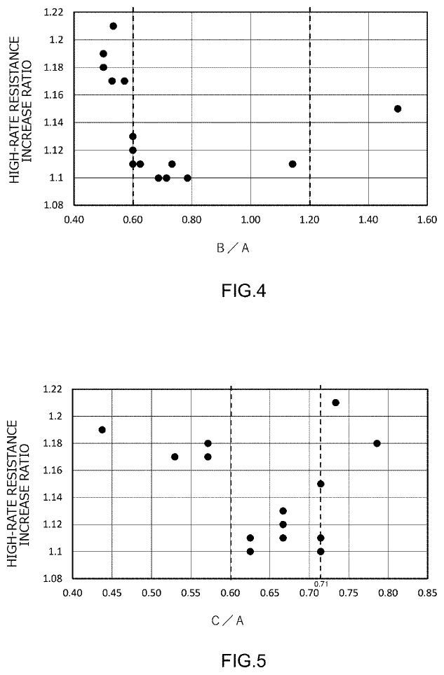

FIG. 4 is a graph showing the relationship between the ratio of the void volume B per unit area of the positive electrode active material layer with respect to the void volume A per unit area of the negative electrode active material layer, i.e., (B/A), and the high-rate resistance increase ratio. FIG. 5 is a graph showing the relationship between the ratio of the void volume C per unit area of the separator with respect to the void volume A per unit area of the negative electrode active material layer, i.e., (C/A), and the high-rate resistance increase ratio.

TABLE 2

| | | | | | NEGATIVE | | SEPA- | | | | HIGH- |
|---|---|---|---|---|---|---|---|---|---|---|---|
| | POSITIVE ELECTRODE | | | | ELECTRODE | | RATOR | | | | RATE |
| | TYPE OF | RATIO OF | | VOID | | VOID | VOID | | | INITIAL | RESIS- |
| | CONDUC- | CONDUCTIVE | DEN- | VOLUME | DEN- | VOLUME | VOLUME | | | RESIS- | TANCE |
| | TIVE | MATERIAL | SITY | B | SITY | A | C | RATIO | RATIO | TANCE | INCREASE |
| | MATERIAL | (w t %) | (g/cm³) | (cm³/cm²) | (g/cm³) | (cm³/cm²) | (cm³/cm²) | 1^{a)} | 2^{b)} | RATIO | RATIO |
| COMPARATIVE | AB | 7.00 | 2.42 | 0.0008 | 1.14 | 0,0015 | 0.0011 | 0.53 | 0.73 | 1.00 | 1.21 |
| EX 1 | | | | | | | | | | | |
| COMPARATIVE | AB | 7.00 | 2.42 | 0.0007 | 1.14 | 0.0014 | 0.0008 | 0.50 | 0.57 | 1.00 | 1.18 |
| EX 2 | | | | | | | | | | | |
| COMPARATIVE | AB | 7.00 | 2.45 | 0.0008 | 1.17 | 0.0014 | 0.0008 | 0.57 | 0.57 | 1.00 | 1.17 |
| EX 3 | | | | | | | | | | | |
| COMPARATIVE | AB | 7.00 | 2.42 | 0.0008 | 1.09 | 0.0016 | 0.0007 | 0.50 | 0.44 | 1.00 | 1.19 |
| EX 4 | | | | | | | | | | | |
| COMPARATIVE | AB | 7.00 | 2.42 | 0.0007 | 1.14 | 0.0014 | 0.0011 | 0.50 | 0.79 | 1.00 | 1.18 |
| EX 5 | | | | | | | | | | | |
| COMPARATIVE | CNT | 0.80 | 1.49 | 0.0021 | 1.17 | 0.0014 | 0.0010 | 1.50 | 0.71 | 1.12 | 1.15 |
| EX 6 | | | | | | | | | | | |
| COMPARATIVE | CNT | 0.80 | 2.75 | 0.0009 | 1.14 | 0.0017 | 0.0009 | 0.53 | 0.53 | 1.05 | 1.17 |
| EX 7 | | | | | | | | | | | |
| EXAMPLE 1 | CNT | 0.80 | 2.55 | 0.0009 | 1.10 | 0.0015 | 0.0010 | 0.60 | 0.67 | 1.00 | 1.12 |
| EXAMPLE 2 | CNT | 0.80 | 2.40 | 0.0010 | 1.14 | 0.0014 | 0.0010 | 0.71 | 0.71 | 1.00 | 1.10 |
| EXAMPLE 3 | CNT | 0.80 | 2.20 | 0.0011 | 1.14 | 0.0014 | 0.0010 | 0.79 | 0.71 | 1.01 | 1.10 |
| EXAMPLE 4 | CNT | 0.80 | 1.80 | 0.0016 | 1.14 | 0.0014 | 0.0010 | 1.14 | 0.71 | 1.04 | 1.11 |
| EXAMPLE 5 | CNT | 0.80 | 2.40 | 0.0010 | 1.14 | 0.0014 | 0.0010 | 0.71 | 0.71 | 1.00 | 1.10 |
| EXAMPLE 6 | CNT | 0.80 | 2.55 | 0.0009 | 1.10 | 0.0015 | 0.0010 | 0.60 | 0.67 | 1.00 | 1.13 |
| EXAMPLE 7 | CNT | 0.80 | 2.40 | 0.0010 | 1.14 | 0.0016 | 0.0010 | 0.63 | 0.63 | 1.00 | 1.11 |
| EXAMPLE 8 | CNT | 0.80 | 2.47 | 0.0009 | 1.10 | 0.0015 | 0.0010 | 0.60 | 0.67 | 1.00 | 1.12 |
| EXAMPLE 9 | CNT | 0.80 | 2.36 | 0.0011 | 1.17 | 0.0015 | 0.0010 | 0.73 | 0.67 | 1.00 | 1.11 |
| EXAMPLE 10 | CNT | 0.80 | 2.40 | 0.0011 | 1.10 | 0.0016 | 0.0010 | 0.69 | 0.63 | 1.00 | 1.10 |
| EXAMPLE 11 | CNT | 0.80 | 2.55 | 0.0009 | 1.17 | 0.0015 | 0.0010 | 0.60 | 0.67 | 1.00 | 1.11 |

^{a)}ratio 1 = void volume B per unit area of the positive electrode active material layer/void volume A per unit area of the negative electrode active material layer
^{b)}ratio 2 = void volume C per unit area of the separator with respect to the void volume A per unit area of the negative electrode active material layer

Regarding the initial resistance ratio, “lower than 1.05” was evaluated as good. Regarding the high-rate resistance increase ratio, “lower than 1.15” was evaluated as good. It is seen from Table 2 and FIG. 4, the batteries in examples 1 through 11, which contain carbon nanotubes as a conductive material and satisfy 0.6≤B/A≤1.2 where (B/A) is the ratio of the void volume B per unit area of the positive electrode active material layer with respect to the void volume A per unit area of the negative electrode active material layer, have an initial resistance ratio lower than 1.05 and a high-rate resistance increase ratio lower than 1.15. As can be seen from this, a battery including a positive electrode active material layer that contains at least a positive electrode active material and carbon nanotubes as a conductive material and satisfying 0.6≤B/A≤1.2 where B/A is the ratio of the void volume of the positive electrode active material layer with respect to the void volume of the negative electrode active material layer has a low initial resistance and a low resistance increase ratio after high-rate charge and discharge. Namely, it is seen that the non-aqueous electrolytic secondary battery disclosed herein has both of superb resistance characteristics and superb high-rate characteristics.

It is seen from Table 2 and FIG. 5 that the batteries in examples 1 through 11 satisfy 0.6≤C/A≤0.71 where C/A is the ratio of the void volume C per unit area of the separator with respect to the void volume A per unit area of the negative electrode active material layer. Therefore, it is seen that a non-aqueous electrolytic secondary battery having a ratio, among the void volumes of the positive electrode active material layer, the negative electrode active material layer and the separator, satisfying 0.6≤B/A≤1.2 and 0.6≤C/A≤0.71 has a low initial resistance and a low resistance increase ratio after high-rate charge and discharge.

While specific examples of the technology disclosed herein have been described in detail, the above description provides a mere example and does not limit the scope of the claims. The technology defined by the claims encompasses various modifications and alterations of the specific examples described above.

What is claimed is:

1. A non-aqueous electrolytic secondary battery, comprising:
a rolled electrode assembly including a positive electrode, a negative electrode and a separator, the positive electrode and the negative electrode being rolled with the separator being sandwiched between the positive electrode and the negative electrode;
a non-aqueous electrolytic solution; and
a quadrangular battery case accommodating the rolled electrode assembly and the non-aqueous electrolytic solution,
wherein:
the positive electrode includes a positive electrode active material layer containing at least a positive electrode active material and carbon nanotubes as a conductive material,
the negative electrode includes a negative electrode active material layer containing a negative electrode active material, and
where a void volume per unit area of the negative electrode active material layer is A (cm³/cm²) and a void volume per unit area of the positive electrode active material layer is B (cm³/cm²), the non-aqueous electrolytic secondary battery satisfies 0.6≤B/A≤1.2.

2. The non-aqueous electrolytic secondary battery according to claim 1, wherein the separator is porous, and where a void volume per unit area of the separator is C (cm³/cm²), the non-aqueous electrolytic secondary battery satisfies 0.6≤B/A≤1.2 and 0.6≤C/A≤0.71.

3. The non-aqueous electrolytic secondary battery according to claim 2, wherein:
the void volume A per unit area of the negative electrode active material layer is 0.0014 cm³/cm² or larger and 0.0016 cm³/cm² or smaller,
the void volume B per unit area of the positive electrode active material layer is 0.0009 cm³/cm² or larger and 0.0016 cm³/cm² or smaller, and
the void volume C per unit area of the separator is 0.0007 cm³/cm² or larger and 0.0011 cm³/cm² or smaller.

4. The non-aqueous electrolytic secondary battery according to claim 1, wherein where a total weight of the positive electrode active material layer is 100% by weight, the carbon nanotubes are contained in the positive electrode active material layer at a content of 0.5% by weight or higher and 5% by weight or lower.

5. An assembled battery including a plurality of the non-aqueous electrolytic secondary batteries according to claim 1, wherein:
the plurality of non-aqueous electrolytic secondary batteries are aligned in a direction, and
the plurality of non-aqueous electrolytic secondary batteries are restrained so as to be supplied with a load in a direction in which the plurality of non-aqueous electrolytic secondary batteries are aligned.
